(19) United States
(12) Patent Application Publication
(10) Pub. No.: US 2012/0112965 A1
(43) Pub. Date: May 10, 2012

(54) BROADBAND ANTENNA

(75) Inventors: Li-Jean Yen, Hsinchu County (TW); Shih-Chiang Wei, Hsinchu County (TW); Jhih - Yuan Ke, Hsinchu County (TW)

(73) Assignee: Wistron NeWeb Corporation, Hsinchu County (TW)

(21) Appl. No.: 13/048,547

(22) Filed: Mar. 15, 2011

(30) Foreign Application Priority Data
Nov. 10, 2010 (TW) 099221770

(51) Int. Cl. H01Q 1/38

(52) U.S. Cl. 343/700 MS

(57) ABSTRACT

A broadband antenna includes a substrate, a radiator element disposed on a first surface of the substrate, a grounding element, a conductor element, a conductor arm, and a conductor piece disposed on a second surface of the substrate. The conductor element is provided with a feed point. The conductor element interconnects the radiator element and the grounding element and includes a first conductor section, a second conductor section, and a third conductor section interconnecting the first conductor section and the second conductor section. The third conductor section includes a first part, and a second part connected between the first part and the second conductor section. The first conductor section configures the radiator element into a first radiator portion and a second radiator portion. The conductor piece is conductively coupled to the radiator element and overlaps with projections of the first radiator portion, the first conductor section, the first part, and the conductor arm onto the second surface.

### CROSS-REFERENCE TO RELATED APPLICATION

This application claims priority of Taiwanese Application No. 099221770, filed on Nov. 10, 2010.

### BACKGROUND OF THE INVENTION

1. Field of the Invention

The present invention relates to a broadband antenna, more particularly to a broadband antenna realized by improving bandwidth of an inverted F antenna.

2. Description of the Related Art

Owing to flourishing development of wireless communications technology, communications protocols in different frequency bands continue to be established. For conforming with a design trend of miniaturization in current electronic devices, reducing dimensions of an antenna and increasing operation bandwidth of an antenna so as to decrease a number of antennas to be deployed have become a development direction of antennas.

A dual band antenna realized by improvement of an inverted F antenna is disclosed in Taiwanese Patent Number 563274. The dual band antenna disclosed therein is capable of operating in a low frequency band and a high frequency band. Accordingly, if a broadband antenna with broader bandwidth may be realized by further improvement of the aforementioned dual band antenna so as to be applied in different communications protocols, such an antenna may further achieve a goal of antenna development and increase convenience in usage of wireless electronic devices.

### SUMMARY OF THE INVENTION

Therefore, an object of the present invention is to provide a broadband antenna that has increased operation frequency bandwidth.

Accordingly, the broadband antenna of the present invention includes a substrate, a radiator element, a grounding element, a conductor element, a conductor arm, and a conductor piece. The substrate has a first surface and a second surface that are spaced apart from each other. The radiator element is disposed on the first surface of the substrate. The grounding element is disposed on the first surface of the substrate, is spaced apart from the radiator element, and is provided with a grounding point. The conductor element is disposed on the first surface of the substrate and is provided with a feed point for feeding with signals. The conductor element includes a first conductor section extending from the radiator element toward the grounding element, a second conductor section extending from the grounding element toward the radiator element, and a third conductor section interconnecting the first conductor section and the second conductor section. The first conductor section configures the radiator element into a first radiator portion for resonating in a high frequency band and a second radiator portion for resonating in a low frequency band. The conductor arm is disposed on the first surface of the substrate. The conductor arm extends from the third conductor section toward the second radiator portion and is spaced apart from the second radiator portion to form a coupling clearance therebetween. The conductor piece is disposed on the second surface of the substrate and is conductively coupled to the radiator element. The conductor piece overlaps with projections of the first radiator portion, the first conductor section, the first part, and the conductor arm onto the second surface.

The effect of the present invention resides in that by using the conductor arm and the conductor piece to adjust matching of low frequency resonating mode and high frequency resonating mode, the operation bandwidth may be increased.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view illustrating a first surface of a preferred embodiment of a broadband antenna of the present invention;

FIG. 2 is a schematic view illustrating a second surface of the preferred embodiment opposite to the first surface; and

FIG. 3 is a Voltage Standing Wave Ratio (VSWR) plot of the preferred embodiment.

### DETAILED DESCRIPTION OF THE PREFERRED EMBODIMENT

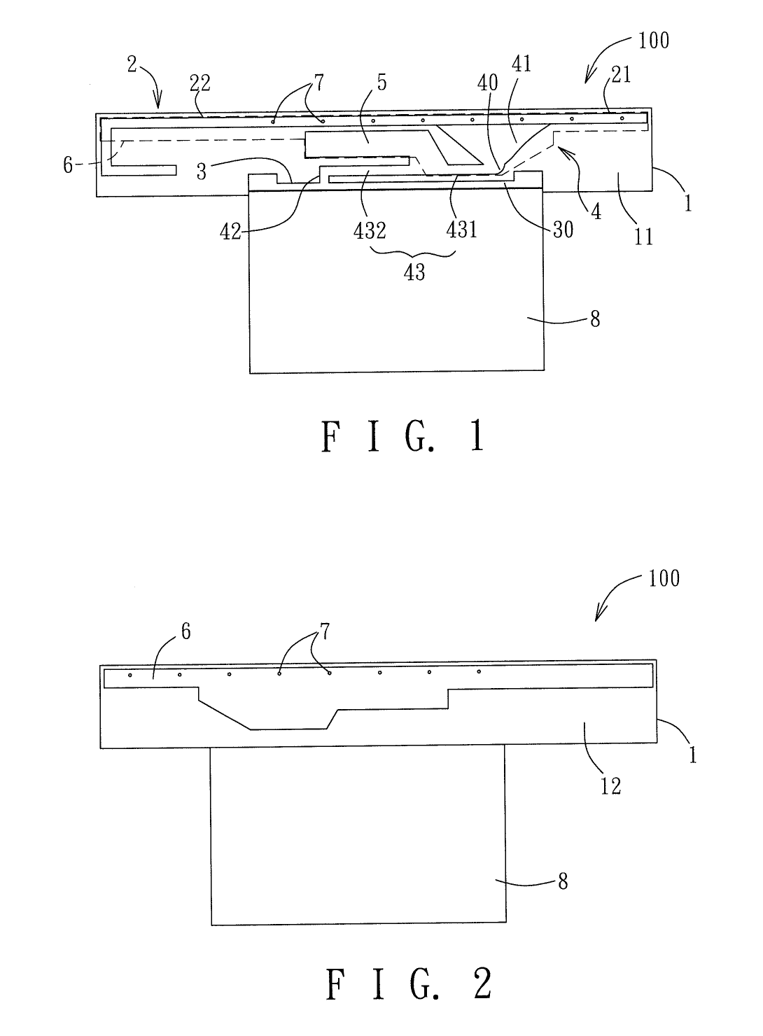

Referring to FIG. 1 and FIG. 2, a preferred embodiment of a broadband antenna of the present invention includes a substrate 1, a radiator element 2, a grounding element 3, a conductor element 4, a conductor arm 5, and a conductor piece 6. The substrate 1 is substantially rectangular in shape, and has a first surface 11 and a second surface 12 that are spaced apart from each other. The substrate 1 further has first and second edges opposite to each other, and third and fourth edges extending between the first and second edges.

The radiator element 2 is disposed on the first surface 11 of the substrate 1, and extends along and adjacent to the first edge of the substrate 1. The radiator element 2 is substantially in a shape of a strip, and has an end extending at an angle of substantially 90 degrees toward the second edge along the third edge and further extending at an angle of substantially 90 degrees toward the fourth edge. The bent radiator element 2 is capable of reducing dimensions of the broadband antenna 100.

The grounding element 3 is disposed on the first surface 11 of the substrate 1, is spaced apart from the radiator element 2, and is disposed adjacent to the second edge of the substrate 1. The grounding element 3 is substantially in a shape of a strip and extends along the second edge of the substrate 1 such that the radiator element 2 has a portion parallel to the grounding element 3. The grounding element 3 is provided with a grounding point 30 and is to be connected to a conductive foil 8 for increasing grounding area.

The conductor element 4 is disposed on the first surface 11 of the substrate 1 and is provided with a feed point 40 for feeding with signals. The conductor element 4 includes a first conductor section 41, which is substantially triangular in shape, extending from the radiator element 2 toward the grounding element 3, a second conductor section 42 extending from the grounding element 3 toward the radiator element 2, and a third conductor section 43, which is substantially perpendicular to the second conductor section 42, interconnecting the first conductor section 41 and the second conductor section 42. The third conductor section 43 is substantially parallel to the grounding element 3. The third conductor section 43 includes a first part 431 connected to the first conductor section 41, and a second part 432 connected between the first part 431 and the second conductor section 42. The first conductor section 41 configures the radiator element 2 into a first radiator portion 21 for resonating in a high frequency band and a second radiator portion 22 for resonating in a low frequency band. The first radiator portion 21 is disposed at one side of a junction of the first conductor section 41 and the second radiator portion 22 which is proximate to the fourth edge of the substrate 1. The second radiator portion 22 is disposed at another side of the junction of the first conductor section 41 and the second radiator portion 22 which is proximate to the third edge of the substrate 1. The first radiator portion 21 has a length shorter than that of the second radiator portion 22. The length of each of the first radiator portion 21 and the second radiator portion 22 is substantially equal to one fourth of a respective one of wavelengths of center frequencies of the high frequency band and the low frequency band. The feed point 40 is located in a junction of the first conductor section 41 and the third conductor section 43. The grounding point 30 is adjacent to the feed point 40. The first conductor section 41, which is substantially triangular in shape, is configured for increasing bandwidth of a resonant mode of the low frequency band.

The conductor arm 5 is disposed on the first surface 11 of the substrate 1. The conductor arm 5 extends from the first part 431 of the third conductor section 43 toward the second radiator portion 22 and is spaced apart from the second radiator portion 22 to form a coupling clearance therebetween. The coupling clearance enables the radiator arm 5 to couple capacitively to the second radiator portion 22 for adjusting matching of each of the resonant mode of the low frequency band and a resonant mode of the high frequency band so as to increase bandwidths thereof.

The conductor piece 6 is disposed on the second surface 12 of the substrate 1 and is conductively coupled to the radiator element 2. The conductor piece 6 overlaps with projections of the first radiator portion 21, the first conductor section 41, the first part 431, the conductor arm 5, and a portion of the second radiator portion 21 onto the second surface 12 but does not overlap with projections of the second part 432 and the grounding element 3 onto the second surface 12. The conductor piece 6 is configured for adjusting matching of the resonant modes of each of the low frequency band and the high frequency band so as to increase bandwidth of the resonant mode of the high frequency band. In this embodiment, the broadband antenna 100 further includes a plurality of conductive vias 7 formed through the radiator element 2, the substrate 1, and the conductor piece 6. The radiator element 2 is coupled electrically to the conductor piece 6 through the conductive vias such that the radiator element 2 is conductively coupled to the conductor piece 6. Certainly, the broadband antenna 100 may also use conductive wires interconnecting blind vias (not shown) disposed in the substrate 1, or one of iron pieces and conductive wires disposed on surfaces of the substrate 1 and interconnecting the radiator element 2 and the conductor piece 6 such that the radiator element 2 is conductively coupled to the conductor piece 6. In another preferred embodiment, the conductor piece 6 may merely overlap with projections of the first radiator portion 21 and the conductor arm 5 onto the second surface 12 without overlapping with projections of the second radiator portion 22, the first conductor section 41, and the first part 431 onto the second surface 12.

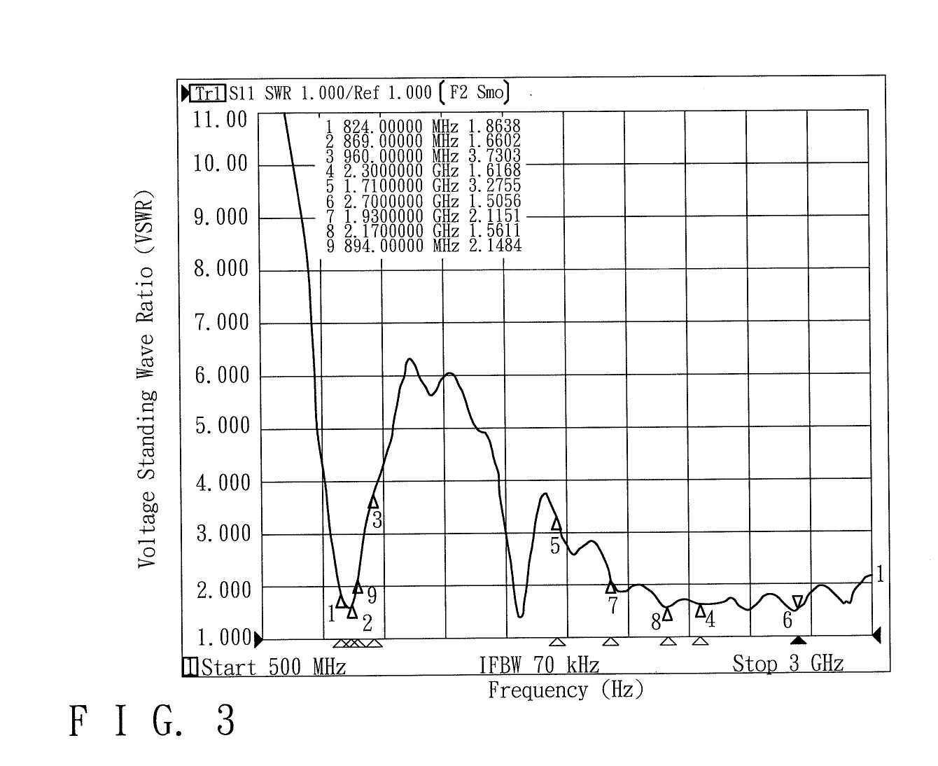

Referring to FIG. 3, a Voltage Standing Wave Ratio (VSWR) plot of the broadband antenna 100 of the preferred embodiment illustrates that the broadband antenna 100 of the preferred embodiment may operate in frequencies ranging from 824 MHz to 960 MHz, from 1710 MHz to 2170 MHz, and from 2300 MHz to 2700 MHz, in which the values of VSWR at frequencies between 2170 MHz and 2700 MHz are smaller than 2.

In summary, the broadband antenna 100 of the preferred embodiment uses the conductor piece 6 disposed on the second surface 12 to adjust matching of the resonant modes of each of the low frequency band and the high frequency band so as to increase bandwidth of the resonant mode of the high frequency band. Meanwhile, the first conductor section 41 and the conductor arm are adopted for increasing bandwidth of the low frequency band and adjusting matching of the resonant modes of each of the low frequency band and the high frequency band.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A broadband antenna comprising:
a substrate having a first surface and a second surface that are spaced apart from each other;
a radiator element disposed on said first surface of said substrate;
a grounding element disposed on said first surface of said substrate, spaced apart from said radiator element, and provided with a grounding point;
a conductor element disposed on said first surface of said substrate and provided with a feed point for feeding with signals, said conductor element including:
a first conductor section extending from said radiator element toward said grounding element,
a second conductor section extending from said grounding element toward said radiator element, and
a third conductor section interconnecting said first conductor section and said second conductor section,
said first conductor section configuring said radiator element into a first radiator portion for resonating in a high frequency band and a second radiator portion for resonating in a low frequency band;
a conductor arm disposed on said first surface of said substrate, said conductor arm extending from said third conductor section toward said second radiator portion and being spaced apart from said second radiator portion to form a coupling clearance therebetween; and
a conductor piece disposed on said second surface of said substrate and conductively coupled to said radiator element, said conductor piece overlapping with projections of said first radiator portion and said conductor arm onto said second surface.

2. The broadband antenna as claimed in claim 1, wherein said conductor piece further overlaps with a projection of said first conductor section onto said second surface.

3. The broadband antenna as claimed in claim. 2, wherein said third conductor section includes a first part connected to said first conductor section, and a second part connected between said first part and said second conductor section, said conductor arm extending from said first part toward said second radiator portion, said conductor piece further overlapping with a projection of said first part onto said second surface.

4. The broadband antenna as claimed in claim 3, wherein said conductor piece further overlaps with at least a portion of a projection of said second radiator portion onto said second surface.

5. The broadband antenna as claimed in claim 4, wherein said conductor piece is coupled electrically to said radiator element.

6. The broadband antenna as claimed in claim 1, further comprising a plurality of conductive vias formed through said radiator element, said substrate, and said conductor piece, said radiator element being coupled electrically to said conductor piece through said conductive vias.

7. The broadband antenna as claimed in claim 1, wherein said first conductor section is substantially triangular in shape.

8. The broadband antenna as claimed in claim 1, wherein said feed point is located at a junction of said first conductor section and said third conductor section, said grounding point being adjacent to said feed point.

9. The broadband antenna as claimed in claim 1, wherein at least a portion of said radiator element is substantially parallel to said grounding element.

10. The broadband antenna as claimed in claim 1, wherein said third conductor section is substantially parallel to said grounding element.

11. The broadband antenna as claimed in claim 1, wherein said second conductor section is substantially perpendicular to said third conductor section.
